(19) United States
(12) Patent Application Publication
(10) Pub. No.: US 2024/0081397 A1
(43) Pub. Date: Mar. 14, 2024

(54) Connector for an electronic cigarette

(71) Applicant: CHARLES CHING LAR WONG, PASADENA, CA (US)

(72) Inventor: CHARLES CHING LAR WONG, PASADENA, CA (US)

(21) Appl. No.: 17/981,491

(22) Filed: Nov. 7, 2022

(30) Foreign Application Priority Data
Sep. 13, 2022 (CN) 202222415686.3

(51) Int. Cl. A24F 40/40; F16B 2/20

(52) U.S. Cl. CPC A24F 40/40; F16B 2/20

(57) ABSTRACT

A connector, adapted for use in an electronic cigarette; the connector has a connector body and a heat insulating component; one end of the connector body is adapted to be sleeved by an atomizer; another end of the connector body is adapted to be connected to a battery; the heat insulating component is sleeved inside the connector body; a plurality of disengagement prevention structures are provided between the heat insulating component and the connector body; the disengagement prevention structures are a plurality of projections arranged to be spaced apart from one another to provide frictional forces between the heat insulating component and the connector body.

### BACKGROUND OF THE INVENTION

The present invention relates to a connector structure for an electronic cigarette.

A prior art electronic cigarette comprises an atomizer and a battery. The atomizer and the battery are connected through a connector. Since the atomizer will usually produce heat, the connector is usually provided with a heat insulating component to prevent the heat from transferring to the battery. In the prior art, the connector and the heat insulating component are connected by glues or by interference fit. It is not environmentally friendly to use glues. In case of interference fit, the connector and the heat insulating component can be easily loosened with respect to each other under significant external force.

### BRIEF SUMMARY OF THE INVENTION

It is an object of the present invention to solve the technical problems in the prior art by providing a connector for an electronic cigarette. To achieve said object of the present invention, the following technical solutions are provided:

A connector, adapted for use in an electronic cigarette; the connector comprises a connector body and a heat insulating component; one end of the connector body is adapted to be sleeved by an atomizer; another end of the connector body is adapted to be connected to a battery; the heat insulating component is sleeved inside the connector body; a plurality of disengagement prevention structures are provided between the heat insulating component and the connector body.

Further, the disengagement prevention structures are a plurality of projections arranged to be spaced apart from one another to provide frictional forces between the heat insulating component and the connector body.

Further, the projections are mounted on the heat insulating component.

Further, the projections and the heat insulating component are formed integrally as one whole piece.

Further, the heat insulating component is a ceramic component.

The present invention has the following advantages: In the present invention, the connector body and the heat insulating component are prevented from disengagement through the disengagement prevention structures. Projections are used to increase the static frictional forces between the connector body and the heat insulating component to prevent the connector body and the heat insulating component from disengaging and rotating with respect to each other. Compared with prior art, the present invention does not require glue application such that the production process is optimized and the making of the product is more environmentally friendly, thereby ensuring good health and good safety. Moreover, the product can be quickly assembled, resulting in increased assembling efficiency and lowered cost of production.

### BRIEF DESCRIPTION OF THE DRAWINGS

In order to describe the technical solutions of the present invention more clearly, the drawings required to describe the embodiments are briefly introduced below. Apparently, the drawings described below illustrate only some of the possible embodiments of the present invention. A person skilled in the art, without any additional inventive input, may also obtain other drawings based on the drawings described below.

FIG. 1 is a schematic structural view of the connector of the present invention.

FIG. 2 is a schematic structural view of a projection having a triangular cross section.

FIG. 3 is a schematic structural view of a projection having a semi-circular cross section.

FIG. 4 is a schematic structural view of a projection having a quadrilateral cross section.

It should be noted that, the drawings are not necessarily drawn in scale. The drawings are only drawn illustratively so as not to undermine the comprehension by the reader.

### DETAILED DESCRIPTION OF THE INVENTION

The technical solutions provided according to the embodiments of the present invention will be further described clearly and comprehensively with reference to the accompanying drawings. Apparently, the described embodiments are only some but not all of the possible embodiments of the present invention. Any other embodiments obtainable based on the disclosed embodiments herein by a person skilled in the art without any inventive input should also fall within the scope of the protection of the present invention.

In the description, it should be understood that orientations or positional relationships indicated by the terms “upper”, “lower”, “left”, “right”, “front”, “rear”, “top”, “bottom”, “inner”, “outer”, “within”, “vertical”, “horizontal” and the like are orientations or positional relationships as shown in the drawings, and are only for the purpose of facilitating the description of the present invention instead of indicating or implying that devices, elements or constituents being indicated must have particular orientations, or be constructed and operated in the particular orientations.

Also, some of the terms mentioned above may contain other meanings apart from indicating orientations or positional relationships. For example, the term “upper” in some contexts may refer to a certain kind of interrelationship or connection. A person skilled in the art can understand the meaning of the terms in the description according to specific contexts.

Further, terms such as “mount”, “configure”, “comprise”, “connect”, “link” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present invention can be understood according to specific contexts.

In addition, the terms “first” and “second” are only used for the purpose of differentiating different devices, components or constituents (wherein the types and structures of said different devices, components or constituents may be the same or different), and may not be understood as indicating or implying the relative importance or quantity of the devices, components or constituents indicated. The term “plurality” refers to two or more, unless otherwise specified.

It should also be understood that, the terms in the description are only used for the purpose of describing specific embodiments, but they are not intended to limit the present invention. As used in the description and claims of the present invention, the singular form implied by the terms “a”, “one” and “this” may imply plural form as well, unless otherwise specified according to the contexts.

Moreover, the term “and/or” used in the description and claims may imply any one of the various items linked by the term, any possible combination of the various items, all possible combinations of the various items, and all of the above situations.

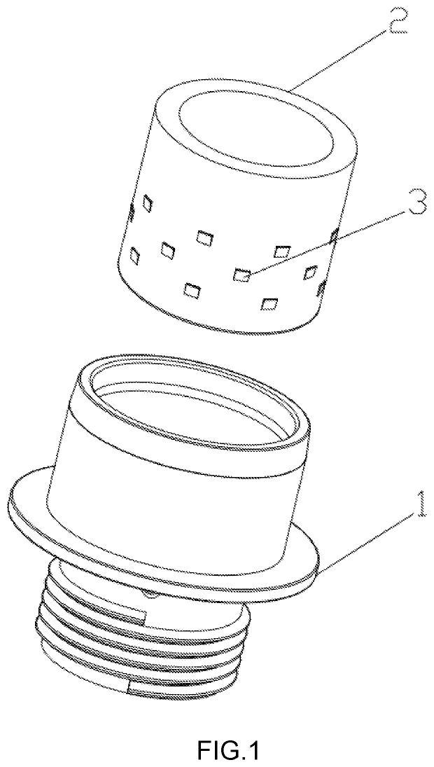

As shown in FIG. 1, the present invention provides a connector for an electronic cigarette; the connector comprises a connector body 1 and a heat insulating component 2; one end of the connector body 1 is configured to be sleeved by an atomizer; another end of the connector body 1 is configured to be connected to a battery. The heat insulating component 2 is sleeved inside the connector body 1. A plurality of disengagement prevention structures 3 are provided between the heat insulating component 2 and the connector body 1. The disengagement prevention structures 3 are a plurality of projections arranged to be spaced apart from one another to provide frictional forces between the heat insulating component 2 and the connector body 1.

In the present invention, the connector body and the heat insulating component are prevented from disengagement through the disengagement prevention structures. In the present embodiment, projections are used to increase the static frictional forces between the connector body and the heat insulating component to prevent the connector body and the heat insulating component from disengaging and rotating with respect to each other. Compared with prior art, the present invention does not require glue application such that the production process is optimized and the making of the product is more environmentally friendly, thereby ensuring good health and good safety. Moreover, the product can be quickly assembled, resulting in increased assembling efficiency and lowered cost of production.

According to another embodiment of the present invention, the projections are mounted on the heat insulating component.

According to another embodiment of the present invention, the projections and the heat insulating component are formed integrally as one whole piece.

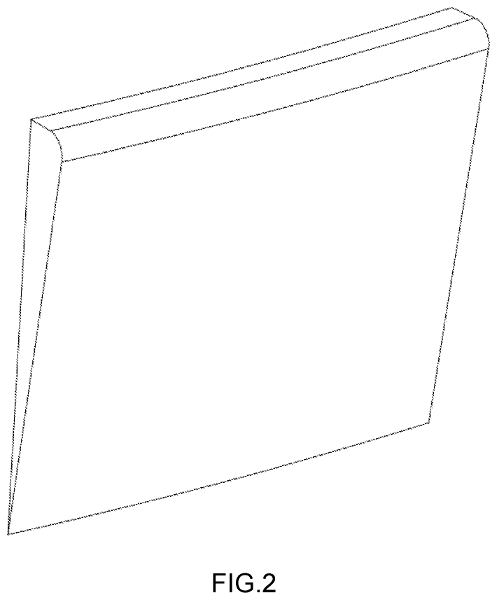

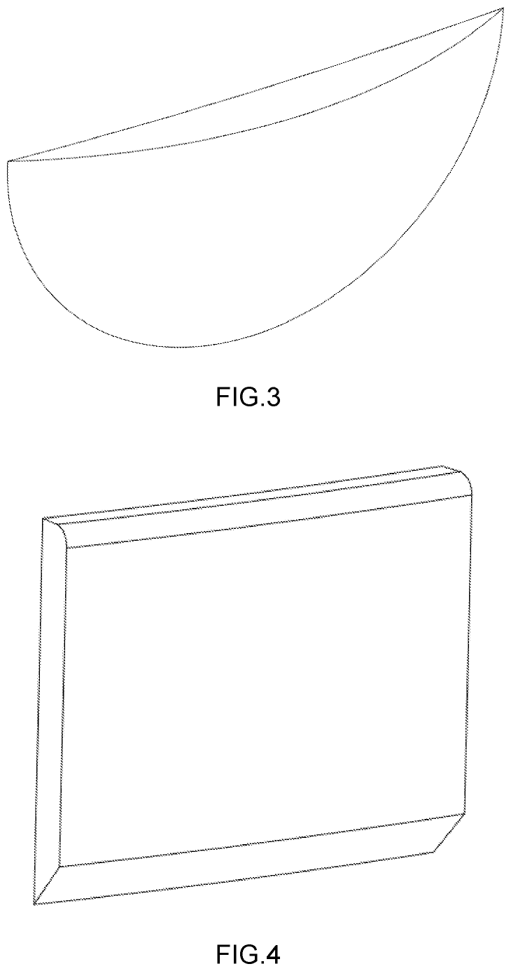

According to another embodiment of the present invention, each of the projections has a triangular cross section (see FIG. 2), a semi-circular cross section (see FIG. 3) or a quadrilateral cross section (see FIG. 4). Projections having such described cross sections achieve better locking effect between the connector body and the heat insulating component.

According to another embodiment of the present invention, the heat insulating component is a ceramic component. Specifically, the heat insulating component is made from ceramic powders through a series of manufacturing processes such as molding, degreasing, high temperature sintering and polishing. The heat insulating component obtained has various advantages such as high melting point, high degree of hardness, and resistance to wearing and oxidation.

1. Mechanical properties: The ceramic heat insulating component obtained has a high degree of stiffness and hardness (1500HV), and is highly resistant to pressure.

2. Thermal properties: The ceramic heat insulating component obtained has a high melting point (above 500° C.), great chemical stability under high temperature, small thermal expansion coefficient, low thermal conductivity, good thermal insulation effect, good dimensional stability, and good performance according to thermal shock test.

In view of the various advantages of ceramic material as described above, the use of ceramic material promotes better health and environmental friendliness. The heat insulating component made from ceramic material can fully satisfy the operating conditions in the core of the atomizer. The properties of ceramic material have obvious advantages.

It should also be noted that, different embodiments of the present invention and the different features mentioned in the different embodiments may be combined to form other new embodiments not described herein so long as the combined embodiments and/or features are compatible.

The above description only describes the preferred embodiments of the present invention. The description is not intended to limit the present invention in terms of the form of the present invention. The scope of the protection of the present invention should be interpreted according to the claims. Although the present invention is disclosed above according to some preferred embodiments which are not intended to limit the present invention, any person skilled in the art, without departing from the scope of the present invention, may obtain other embodiments of equivalent technical effects by making slight changes or modifications based on the above disclosure. Any other technical solutions obtained by any simple changes, modifications and alternative configurations of the disclosed embodiments according to the essence of the present invention without departing from the technical scheme of the present invention should also fall within the scope of present invention.

What is claimed is:

1. A connector, adapted for use in an electronic cigarette; wherein the connector comprises a connector body and a heat insulating component; one end of the connector body is adapted to be sleeved by an atomizer; another end of the connector body is adapted to be connected to a battery; the heat insulating component is sleeved inside the connector body; a plurality of disengagement prevention structures are provided between the heat insulating component and the connector body; the disengagement prevention structures are a plurality of projections arranged to be spaced apart from one another to provide frictional forces between the heat insulating component and the connector body.

2. The connector of claim 1, wherein the projections are mounted on the heat insulating component.

3. The connector of claim 2, wherein the projections and the heat insulating component are formed integrally as one whole piece.

4. The connector of claim 2, wherein each of the projections has a triangular cross section, a semi-circular cross section, or a quadrilateral cross section.

5. The connector of claim 1, wherein the heat insulating component is a ceramic component.
